(19) United States
(12) Patent Application Publication
(10) Pub. No.: US 2023/0130392 A1
(43) Pub. Date: Apr. 27, 2023

(54) PNEUMATIC VEHICLE TIRE WITH NOISE ABSORBER, AND METHOD FOR DETECTING A PNEUMATIC VEHICLE TIRE WITH NOISE ABSORBER AND FOR RECYCLING A PNEUMATIC VEHICLE TIRE WITH NOISE ABSORBER

(71) Applicant: Continental Reifen Deutschland GmbH, Hannover (DE)

(72) Inventors: Mikheil Doroshenko, Garbsen (DE); Christian Kunze, Hannover (DE)

(73) Assignee: Continental Reifen Deutschland GmbH, Hannover (DE)

(21) Appl. No.: 17/760,440

(22) PCT Filed: Nov. 30, 2020
(86) PCT No.: PCT/EP2020/083934

§ 371 Date: Aug. 9, 2022

(30) Foreign Application Priority Data
Feb. 10, 2020 (DE) 10 2020 201 582.1

(51) Int. Cl. B60C 19/00

(52) U.S. Cl. CPC B60C 19/002

(57) ABSTRACT

The invention relates to a pneumatic vehicle tire with at least one sound absorber adhesively attached in its interior to the inner surface opposite the tread. The invention further relates to a process for detecting a pneumatic vehicle tire with a sound absorber and to a process for recycling a pneumatic vehicle tire with a sound absorber.

According to the invention the radially inward-facing surface of the sound absorber has at least one colorant applied to it.

The invention relates to a pneumatic vehicle tire with at least one sound absorber adhesively attached in its interior to the inner surface opposite the tread. The invention further relates to a process for detecting a pneumatic vehicle tire with a sound absorber and to a process for recycling a pneumatic vehicle tire with a sound absorber.

It is known to provide pneumatic vehicle tires with sound absorbers to reduce driving sound. The sound absorber is typically in the form of a foam ring which reduces the vibration of air in the tire and thus leads to an improvement in the sound behavior in the vehicle. The foam ring may be made of open-celled foam and is also referred to as an “interior absorber”.

The sound absorber is, for example, a polyurethane foam ring and is therefore made of different materials to the other tire components.

However, it is also possible to attach a plurality of sound absorbers as disclosed in DE 102017210929 A1 or EP 1 510 366 A1.

Recycling of pneumatic vehicle tires with sound absorbers encounters the problem that prior to the customary comminution of the tires a material separation is desirable, i.e. the sound absorber should be separated in particular.

However depending on the optical state of the sound absorber—this may have a dark color and/or be dirty—and the light conditions, detection of pneumatic vehicle tires with sound absorbers may be impeded. This in turn impedes the distinguishing and separation of pneumatic vehicle tires with and without sound absorbers, which in turn impedes or retards recycling of the pneumatic vehicle tires against the backdrop of the desired material separation.

It is accordingly an object of the present invention to provide a pneumatic vehicle tire with at least one sound absorber adhesively attached in its interior to the inner surface opposite the tread, wherein the sound absorber has a radially inward-facing surface (pneumatic vehicle tire with sound absorber) which is easier to identify as a pneumatic vehicle tire with a sound absorber and is therefore easier to distinguish from pneumatic vehicle tires without sound absorbers.

The object is achieved when the radially inward-facing surface of the sound absorber has at least one colorant applied to it.

As a result of the pneumatic vehicle tires with sound absorbers comprising at least one colorant on the radially inward-facing surface of the sound absorber, the tires are easier to distinguish from pneumatic vehicle tires without sound absorbers.

In particular detection may be carried out in an automated process with a detector, in particular color detector or photodetector, without any need for individual inspection of the tire by an operator.

However, any operator can also identify such a tire with a sound absorber more quickly and unambiguously as a result of the colorant.

This significantly simplifies and facilitates the recycling of tires with (and without) sound absorbers.

The operations of detection using a detector and identification by an operator are both referred to as “detection” in the context of the present invention.

Since only the surface of the sound absorber is provided with a colorant, the tires may be distinguished from one another without any need to color the whole sound absorber.

The invention is more particularly elucidated hereinbelow and further advantageous embodiments are described. Unless otherwise stated or technically infeasible, different embodiments may also be combined with one another.

The term “radially inward-facing surface” is to be understood as meaning a position which is not the surface with which the sound absorber adheres to the tire inner surface but rather is especially arranged on the sound absorber in the direction of the tire interior, facing away from the tread in the radial direction.

In the case of individual blocks of two or more sound absorbers this is to be understood as every surface oriented inward and not adherent to the tire inner surface.

It is not necessary for the entire radially inward-facing surface to be covered with the colorant. In advantageous embodiments of the invention the colorant covers 50% to 100%, preferably 80% to 100%, in particular 90% to 100%, of the radially inward-facing surface of the sound absorber.

The larger the proportion of the surface provided with the colorant, the more reliably the detection may be carried out.

However, small gaps are not disadvantageous.

In advantageous embodiments the colorant is arranged circumferentially in the form of a stripe, wherein the stripe may be continuous or interrupted. A stripe may be easily circumferentially applied in an automated manner continuously or in sections.

The colorant may in principle have any hue which is sufficiently distinct from the hue of the sound absorber.

In advantageous embodiments the colorant has a colored or white hue that is readily distinguishable from black hues, such as for example according to RAL color codes 1000 to 1037, 2000 to 2013, 3000 to 3033, 4000 to 4012, 5000 to 5026, 6000 to 6038, 7000 to 7048, 8000 to 8029, 9000 to 9003, 9010 or 9016.

This especially allows tires with dark or black sound absorbers to be identified much more easily and reliably.

The colorant is preferably selected from inorganic and organic colorants.

Accordingly a broad spectrum of coloring substances is available and suitable colors can therefore be employed via the colorant(s) which are adapted to the respective detector or are particularly readily detectable using a color detector under the prevailing light conditions.

“White” can also be detected using a color detector.

In advantageous embodiments of the invention the colorant comprises at least one conjugated n-electron system (pi-electron system). There are numerous such organic colorants, so that here too it is possible to choose a suitable colorant which is particularly readily detectable using a color detector especially under the prevailing light conditions.

Such colorants may also be used in a particularly material-saving manner.

The colorant or colorants may be applied as solid substances or via a liquid phase, in particular as a dispersion or solution.

The organic colorant comprising at least one conjugated n-electron system may in principle be any molecule which is preferably colored on account of conjugation.

In preferred embodiments of the invention the organic colorant is selected from the group for example containing, particularly preferably consisting of 1-[(2-chloro-4-nitrophenyl) azo]2-naphthol (Pigment Red 4; CAS-No.: 2814-77-9), 4,4′-[(3,3′-dichloro[1,1′-biphenyl]-4,4′-diyl)bis(azo)]bis[2,4-dihydro-5-methyl-2-phenyl-3H-pyrazol-3-one] (Pigment Orange 13; CAS-No.: 3520-72-7), 1-amino-2-methyl-9,10-anthracenedione (CAS-No.: 82-28-0), Permanent Violet RL (CAS-No.: 6358-30-1), Pigment Yellow 155 (CAS-No.: 68516-73-4), Disperse Blue 1 (CAS-No.: 2475-45-8), Methyl Orange (CAS-No.: 547-58-0).

It is preferable to use a non-carcinogenic and non-toxic colorant.

In advantageous embodiments of the invention the colorant comprises at least one metal atom or metal ion. Such colorants are particularly stable and retain their color over a longer period of time and are washed out comparatively slowly by ingress of water, such as after rain.

The colorant comprising at least one metal atom or metal ion may in principle be any substance which is colored, for example metal complexes comprising organic ligands or inorganic pigments.

In preferred embodiments of the invention the colorant comprising at least one metal atom or metal ion is selected from the group for example containing, particularly preferably consisting of,

### Pigment Blue 27 (CAS-No.: 12240-15-2),

Barium chromate (CAS-No.: 10294-40-3),

### Aureolin (CAS-No.: 13782-01-9),

Egyptian Blue (CaCu[Si₄O₁₀], CAS-No. 15843-33-1).

In further advantageous embodiments the colorant comprises at least one white pigment, such as in particular kaolin, titanium dioxide (TiO₂), barium sulfate (BaSO₄), or calcium carbonate (CaCO₃), especially chalk.

It is also conceivable to use colored chalk.

Various embodiments of how the colorant may be applied to the sound absorber surface are described below. All embodiments are combinable with the described possible configurations and the resulting coverage of the surface of the sound absorber.

In advantageous embodiments of the invention the colorant has been applied to the surface of the sound absorber by means of a dispersion, in particular suspension or emulsion, wherein the dispersion contains from 1% to 80% by weight, preferably from 5% to 50% by weight, particularly preferably from 10% to 30% by weight, very particularly preferably 20% to 30% by weight, of colorants.

The reported amounts in % by weight relate to the total mass of the dispersion before drying.

In advantageous embodiments the dispersion contains at least one binder, such as polystyrene or polymethyl methacrylate or styrene-acrylate copolymer or polyvinyl acetate.

The dispersion is preferably a suspension. In this embodiment the colorant(s) are suspended in a liquid.

The reported amounts in % by weight relate to the total mass of the suspension before drying.

A suspension may be applied easily and in a material-saving manner.

The liquid of the suspension may be any conceivable liquid compatible with the particular sound absorber. In advantageous embodiments of the invention the suspension is an aqueous suspension which is particularly environmentally friendly.

In further advantageous embodiments of the invention the colorant has been applied to the surface of the sound absorber by means of a solution, wherein the solution contains at least one solvent and from 1% to 80% by weight, preferably from 5% to 50% by weight, particularly preferably from 10% to 30% by weight, very particularly preferably 20% to 30% by weight, of colorants.

In this embodiment the colorants are dissolved in a liquid.

The reported amounts in % by weight relate to the total mass of the solution before drying.

In advantageous embodiments the solution too contains at least one binder, such as polystyrene or polymethyl methacrylate or styrene-acrylate copolymer or polyvinyl acetate.

A solution is simple to apply.

The solvent(s) may be any conceivable liquid compatible with the particular sound absorber.

In advantageous embodiments of the invention the solution is an aqueous suspension which is particularly environmentally friendly and non-flammable.

In further preferred embodiments of the invention the solvent is at least one organic solvent. The organic solvent may in principle be any suitable solvent known to those skilled in the art, such as alcohols (mono- or polyalcohols), ketones, esters, aldehydes, aromatics, alkanes such as hexane, or ethers, such as petroleum ether.

In preferred embodiments the organic solvent is selected from solvents which are compatible with the sound absorber and the remaining tire components and do not cause these to swell or dissolve constituents thereof, such as in particular simple alcohols, such as ethanol or isopropanol. These are also relatively environmentally friendly and most water-insoluble colorants are easily soluble in them.

In further advantageous embodiments of the invention the colorant has been applied in the form of a solid, in particular in powder form.

The powder may have been applied by air atomization, for example using a gun, or applied electrostatically.

Depending on the type of sound absorber it may be advantageous to apply an adhesion-promoting layer before application of the solid.

In further advantageous embodiments of the invention the colorant is attached to the radially inward-facing surface of the sound absorber as a constituent of a film. A film too is able to be applied easily and in a material-saving manner, in particular at a constant film thickness.

In advantageous embodiments the colorant has been applied at a film thickness (measured in the radial direction (rR) perpendicular to the axial direction (aR) of the vehicle tire) of 1 μm (micrometer) to 1000 μm.

Particular preference is given to a film thickness of 2 to 400 μm (micrometers), particularly preferably 5 μm to 100 μm.

This allows the sound absorber to receive a color marking in the most material saving manner possible without the pneumatic vehicle tire receiving excessive additional mass, which would result in rolling resistance disadvantages.

In advantageous embodiments of the invention the sound absorber is black or almost black. This means that the sound absorber has a hue according to RAL color codes 9004 to 9007, 9011 or 9017 to 9023 for example.

The sound absorber may also be brown or gray.

The sound absorber of the pneumatic vehicle tire according to the invention may in principle be any element or any combination of elements which in a pneumatic vehicle tire may be attached to the inner surface thereof by adhesion and which reduces/reduce the sound emissions of the tire in vehicle operation.

In a preferred embodiment the at least one sound absorber is at least one porous damping element. Porous materials especially have the advantage that in addition to sound absorption they also introduce into the tire an intrinsic weight that is not excessive and the rolling resistance properties of the tire are therefore not unnecessarily impaired.

The porous material from which the damping element is formed is for example selected from the group containing polyurethane, in particular polyether-based and/or polyester-based polyurethane foams having a density of 18 to 300 kg/m³, preferably 30 to 35 kg/m³, and a hardness of 6.5 kilopascals, polyesters having a density of 18 to 300 kg/m³ preferably 30 to 35 kg/m³, and a hardness of 6.5 kilopascals, polyethers, and also any porous, sound-absorbing material mixtures, for example glass or rock wool, loop-pile or deep-pile fabric or nonwovens or cork. Further possible porous materials which are suitable for utilization as a damping element are for example a melamine resin foam or a builder's foam.

It is particularly preferable when the sound absorber, preferably at least one porous damping element, contains at least one polyurethane. Polyurethane is particularly suitable on account of its specific density and further nature and also its availability.

In a particularly advantageous embodiment the porous damping element is a sound-absorbing foam ring closed or open in the circumferential direction. Said ring ensures even sound absorption and the tire maintains its uniformity. The ring may be closed in the circumferential direction or be open in the form of a strip, wherein the ends of the strip may or may not be in contact or may also overlap.

The foam of the foam ring is preferably an open-celled foam since said foam is best suited for absorbing sound.

It is particularly preferable when the sound absorber is a closed sound-absorbing foam ring made of polyurethane, particularly preferably a polyether-based polyurethane foam.

Such foams are known to those skilled in the art.

The sound absorber(s) may moreover have any desired shape, for example individual elements in the shape of blocks, strips or the like, which may be combined with one another as desired.

The sound absorber or sound absorbers are preferably adhesively attached to the tire inner surface using an adhesive. Exemplary adhesives and combinations of adhesives include: an adhesive tape and/or a silicone-based adhesive and/or a two-component adhesive and/or a construction adhesive and/or a polyurethane adhesive and/or a rubber-based adhesive and/or a tire repair adhesive and/or an instant adhesive and/or an adhesive based on cyanoacrylate and/or based on a water-based acrylic system having a polyethylene terephthalate structure and/or based on acrylonitrile-butadiene rubber in conjunction with a formaldehyde resin dissolved in acetone and/or based on a silane polyether and/or based on a polybutene crosslinked with butyl rubber and/or based on an alkoxysilicone.

Such adhesives especially have the advantage that they can be applied in an amount sufficiently small to ensure that they have cured after bonding. This ensures that they are not tacky after removal of the sound absorber and before comminution during recycling of the tires, thus allowing the tires without the sound absorber to be comminuted in the known manner.

The sound absorber is applied to the inner surface of the tire using processes and apparatuses known to those skilled in the art.

The colorant is applied to the radially inward-facing surface of the sound absorber according to its type. It may in particular be applied as a suspension, emulsion or solution.

The invention further provides a process for detecting a pneumatic vehicle tire according to the invention to distinguish pneumatic vehicle tires comprising a sound absorber from pneumatic vehicle tires without a sound absorber.

In the process according to the invention the sound absorber is detected by an operator or using a detector as a result of the colorant.

The detector may be a photodetector or a color detector. A color detector programmed for certain colors, for example according to the RAL system, is preferred.

Suitable detectors are known to those skilled in the art and are usually computer-aided.

The detector may further be a handheld device or a detector used in an automated process by a robot.

The invention further provides a process for recycling pneumatic vehicle tires according to the invention comprising at least the process steps of:

A) providing the pneumatic vehicle tire to be recycled;
B) detecting the sound absorber as a result of the colorant;
C) separating the sound absorber from the pneumatic vehicle tire;
D) subsequently comminuting the pneumatic vehicle tire without the sound absorber.

In advantageous embodiments the process steps A) to D) are carried out in an automated manner.

The invention further provides a process for recycling pneumatic vehicle tires comprising at least the process steps of:

a) providing pneumatic vehicle tires to be recycled;
b) performing the process according to the invention for detecting a pneumatic vehicle tire according to the invention in order to distinguish pneumatic vehicle tires with a sound absorber from pneumatic vehicle tires without a sound absorber;
c) spatially separating pneumatic vehicle tires comprising a sound absorber from pneumatic vehicle tires without a sound absorber;
d) recycling pneumatic vehicle tires without sound absorbers comprising comminution of the pneumatic vehicle tires;
e) transferring pneumatic vehicle tires comprising a sound absorber to a separate recycling process comprising separation of the sound absorber and comminution of the pneumatic vehicle tires only subsequently.

In advantageous embodiments the process steps a) to e) are carried out in an automated manner. In an advantageous embodiment of the invention step c) is carried out in an automated manner in conjunction with step b).

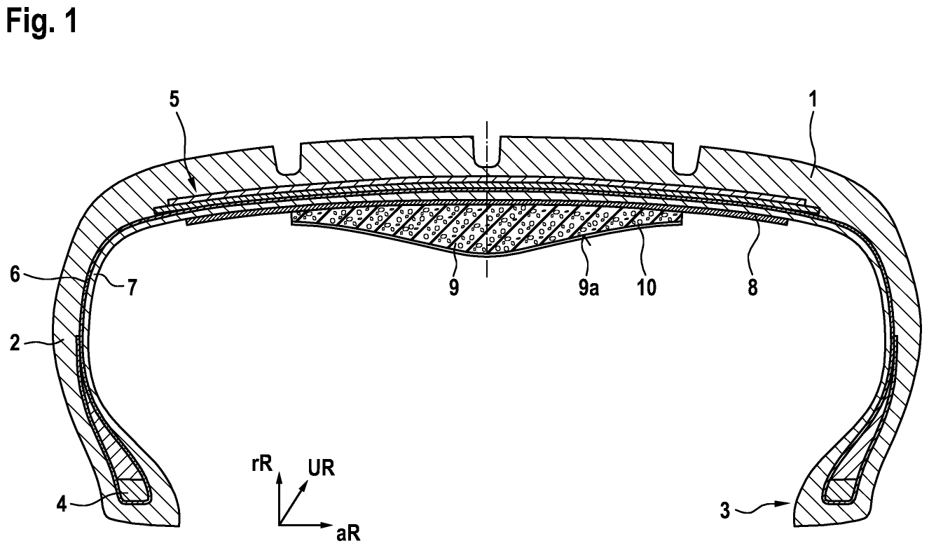

Further particulars of the invention are more particularly elucidated with reference to FIG. 1, which is a schematic representation of an exemplary embodiment.

The invention shall be more particularly elucidated hereinbelow with reference to an exemplary embodiment. An example of a pneumatic vehicle tire according to the invention is shown in FIG. 1 in the context of a schematic representation.

FIG. 1 depicts a cross section through a radial passenger motor vehicle tire having a profiled tread 1, sidewalls 2, bead regions 3, bead cores 4 and also a multi-ply belt bandage 5 and a carcass insert 6. On its inner surface, the tire is covered with an inner layer 7 of an airtight rubber compound. On the inner surface of the inner layer 7 opposite the tread strip 1 a sound-absorbing foam ring as sound absorber 9 is subsequently (in the finished tire) adhesively attached using an adhesive 8, for example a polyurethane-based adhesive 8.

With respect to its sound-absorbing properties the sound-absorbing foam ring is matched to the tire cavity frequency. The sound absorber 9 in the form of a foam ring here has for example approximately an elongated triangle cross section that is symmetrical with respect to the tire equator.

The foam of the foam ring is an open-celled foam since said foam is particularly well suited for absorbing sound. The foam comprises polyurethane for example.

The sound absorber 9 has a radially inward-facing surface 9a.

According to the example in FIG. 1 the radially inward-facing surface 9a of the sound absorber 9 has at least one colorant 10 applied to it.

The colorant 10 is applied, for example, by means of a suspension containing the colorant methyl orange. The sound absorber 9 is therefore colored, namely orange, on the inward-facing surface 9a. The liquid of the suspension is, for example, water, wherein styrene-acrylate copolymer is further present as a binder.

The colorant 10 covers, for example, the entire (100%) surface 9a of the sound absorber 9.

The pneumatic vehicle tire described by way of example can now be distinguished, using a color detector, from pneumatic vehicle tires without a sound absorber by the process according to the invention. To this end, the color detector is programmed in particular to detect orange hues.

This allows pneumatic vehicle tires with sound absorbers according to the invention and pneumatic vehicle tires without sound absorbers to be distinguished from one another in a, for example automated, process according to the invention, spatially separated and supplied to different recycling processes. In the case of a tire according to the invention sound absorbers comprising colorants are initially removed from the tire in an additional step.

### LIST OF REFERENCE NUMERALS

(Part of the Description)
1 Tread
2 Sidewall
3 Bead region
4 Bead core
Belt bandage
6 Carcass insert
7 Inner layer
8 Adhesive
9 Sound absorber
9a Radially inward-facing surface of the sound absorber
10 Colorant
rR radial direction
aR axial direction
UR circumferential direction of the tire

1-12. (canceled)

13. A pneumatic vehicle tire comprising:
a tread, sidewalls and an inner layer opposite the tread;
a sound absorber attached to the inner layer, in the form of a foam ring having an elongated triangle cross section, matched to a tire cavity frequency and having a radially inward facing surface; and
a colorant applied to radially inward facing surface of the sound absorber, the colorant having a different hue than a hue of the sound absorber.

14. The pneumatic vehicle tire of claim 1, the colorant is inorganic.

15. The pneumatic vehicle tire of claim 1, the colorant is organic.

16. The pneumatic vehicle tire of claim 1, the colorant is one of white and blue.

17. The pneumatic vehicle tire of claim 1, the colorant comprises metal.

18. The pneumatic vehicle tire of claim 1, the colorant applied by dispersion with a solution that contains from 1% to 80% by weight of colorants.

19. The pneumatic vehicle tire of claim 1, the colorant covers 50% to 100% of the radially inward-facing surface of the sound absorber.

20. The pneumatic vehicle tire of claim 1, the colorant is a film having a thickness of 1 μm (micrometer) to 1000 μm.

21. The pneumatic vehicle tire of claim 1, the sound absorber having a porous damping element.

22. The pneumatic vehicle tire of claim 21, the porous damping element is a sound-absorbing foam ring closed or open in the circumferential direction.

23. The pneumatic vehicle tire of claim 1, the sound absorber contains a polyurethane.

24. A method of recycling a tire, the method comprising:
providing a tire to be recycled, the tire comprising a sound absorber attached to an inner layer, in the form of a foam ring having an elongated triangle cross section, matched to a tire cavity frequency and having a radially inward facing surface;
determining presence of a colorant on the radially inward facing surface of the sound absorber;
separating the sound absorber from the tire based on the determined presence of the colorant; and
recycling the tire based after removing the sound absorber.

25. The method of claim 24, further comprising transferring the tire to a separate recycling process on determining the presence of the colorant on the sound absorber.
